(19) United States
(12) Patent Application Publication
(10) Pub. No.: US 2017/0330291 A1
(43) Pub. Date: Nov. 16, 2017

(54) IE size - a new solution to major sizing issues

(71) Applicants: Ivan Cotto, Copiague, NY (US); Eric James Bocanegra, Bronx, NY (US)

(72) Inventors: Ivan Cotto, Copiague, NY (US); Eric James Bocanegra, Bronx, NY (US)

(21) Appl. No.: 15/152,453

(22) Filed: May 11, 2016

(51) Int. Cl. G06Q 50/00; G06Q 30/02

(52) U.S. Cl. CPC G06Q 50/01; G06Q 30/0282

(57) ABSTRACT

To solve the major sizing issues, IE Size looks at all the processes and missing elements to correct sizing problems worldwide.

The user input process is where the user measures he or herself by the IE Size measuring points of the users body. The user will also be able to create size ranges on body points for minimum and maximum desired fit. The data from these measurements is uploaded to IE size server databases using software created by IE Size.

The manufacturer input process is where the manufacturer inputs the cut size data of the garments they manufacturer categorized by year, and style number. The data from these measurements is uploaded to IE Size server databases, using software created by IE Size.

The retailer or seller input process is where the retailer selects the garments they sell by manufacturer, by style number, and by year of manufacture. These items are normally items they sell online. This data is stored on IE Size servers as well.

IE Size servers will organize all the data and match the criteria set forth by Users and Manufacturers. Each measuring point of the manufacturers garment will be matched with the users preferred body size, minimums and maximums, at each body size measuring point for the garment. Each Garment that falls into this minimum and maximum range will be tagged as a preferred fit.

When a user shops for garments online the participating retailer will get the correct size information for the user, based on the users unique email address, matching to the garments being viewed.

A new software utility matching your body size, to each manufacturer's sizing criteria for clothing. Every Manufacturer sizes their clothing differently and as a consumer there is no way to define what size you are in that particular manufacturers' clothing. A new software tool to connect manufacturers and consumers in a different unique way which will benefit all involved in the complete retail process.

A system and method for matching clothing size data from clothing manufacturers sizing information, by garment type, to the custom body size data of consumers. A new solution for matching data, which will provide retailers and manufacturers with new unique tools to be used as a backbone to standardize internet clothing purchases. A new more detailed sizing banding approach adding a few more measuring points in the process. A new unique approach for the consumer to input his or her personal sizing data, which will directly link with manufacturer sizing data, creating a custom fit approach to non custom fit or “off the Rack” manufactured clothing items. Email addresses will be utilized as unique identifiers, on our database servers, linking the sizing data held representing our customers body sizes, on our servers, to the size data of every garment item manufactured, on our servers. This new way of matching will provide the consumer with a precise person to garment relationship letting the consumer understand what size he actually is, in this specific garment, by this specific manufacturer. Sizing data from manufacturers shall be stored and accessed in realtime on our database servers, knowing in advance which products actually fit. This new system and method process will significantly reduce product returns on clothing purchases saving clothing retailers millions of dollars in shipping costs. The overall consumer online shopping experience will also be radically improved, and he or she will soon develop improved brand loyalty. This new innovative method of matching personal sizing data will benefit all clothing retailers, manufacturers and most of all, the consumers.

### Description

System and method for the sizing of the body utilizing a new added sizing banding approach (added Measurements). System and method for capturing size data provided by the clothing manufacturers, by specific garment, and by specific garment size. Garment size data will fall between personal body size range calculations based on actual measurements. The precise measurements of the consumers body will determine where the garment fits into the precise size range preferences. The measuring points which will be provided by each garments specific manufactured cut, will fall into the preferred size ranges.

### BACKGROUND OF THE INVENTION

### Field of the Invention

The invention relates to the sizing of clothing and more specifically to measuring points on the body differently, adding measure points for more accurate sizing criteria, when searching and purchasing clothing from online retailers and manufacturers.

Several problems currently exist that reduce the effectiveness of selecting clothing online and offline that currently fit correctly. There are millions of returns each year because clothing does not fit properly. A major problem is that sizing and measurement cut data is not represented anywhere on retailers or manufacturers websites. Also different manufacturers or brands cut there clothes differently making it nearly impossible to know what size you are. This solution will be able to tell the consumer what size he or she is in each specific garment by each manufacturer.

### DESCRIPTION OF THE VIEWS

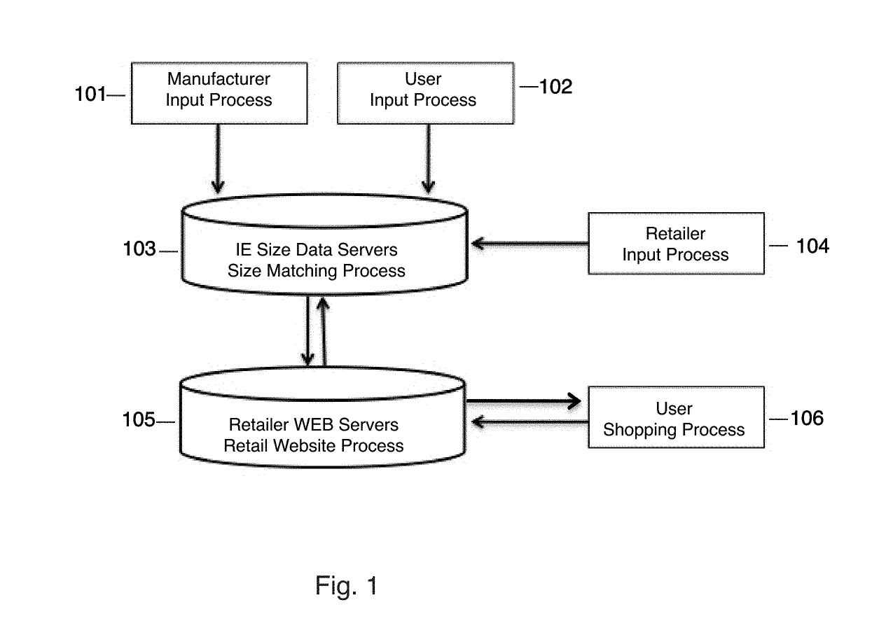

FIG. 1 Overview of Processes. This is flowchart view of all the all major processes needed to create a solution for better ordering of clothing items, the six major processes are shown here. Plan View.

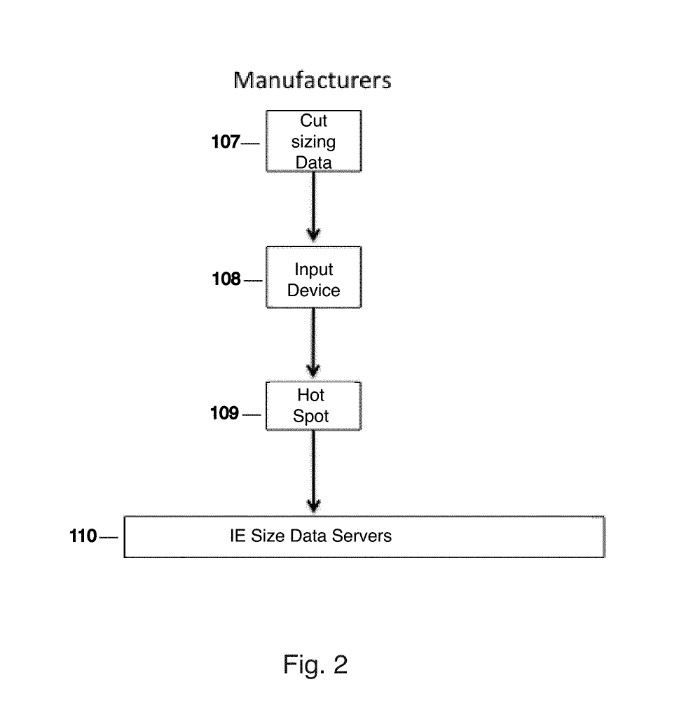

FIG. 2 Manufacturer input process. This is a flowchart view of the manufacturer input process showing how a manufacturer will communicate with IE Size Servers. Plan View.

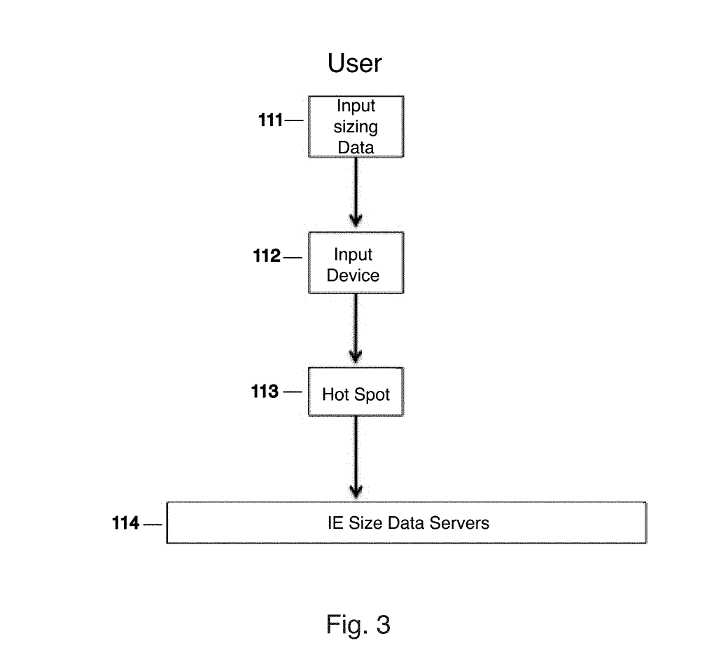

FIG. 3 User input process. This is a flowchart view of the user input process showing how a user will communicate with IE Size Servers. Plan View.

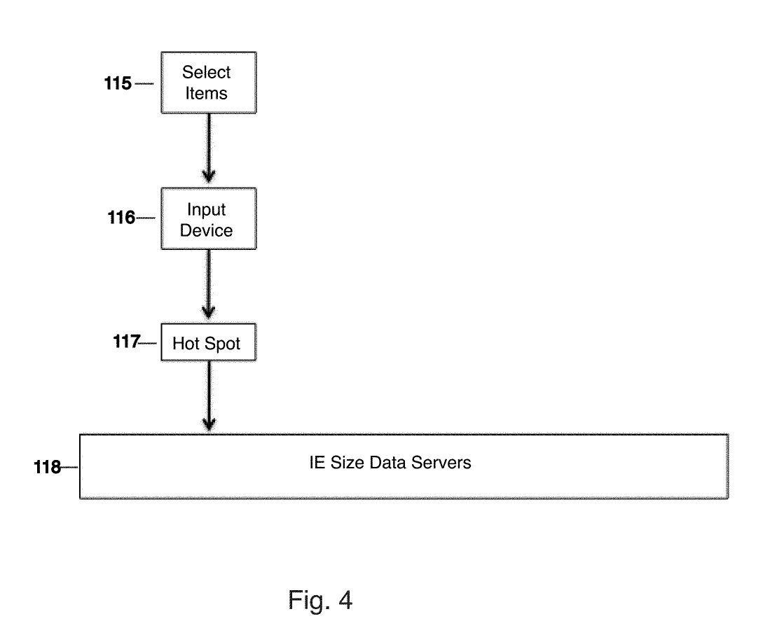

FIG. 4 Retail input process. This is a flowchart view of the retailer input process, showing how retail stores and direct selling manufacturers will communicate with IE Size Servers. Plan View.

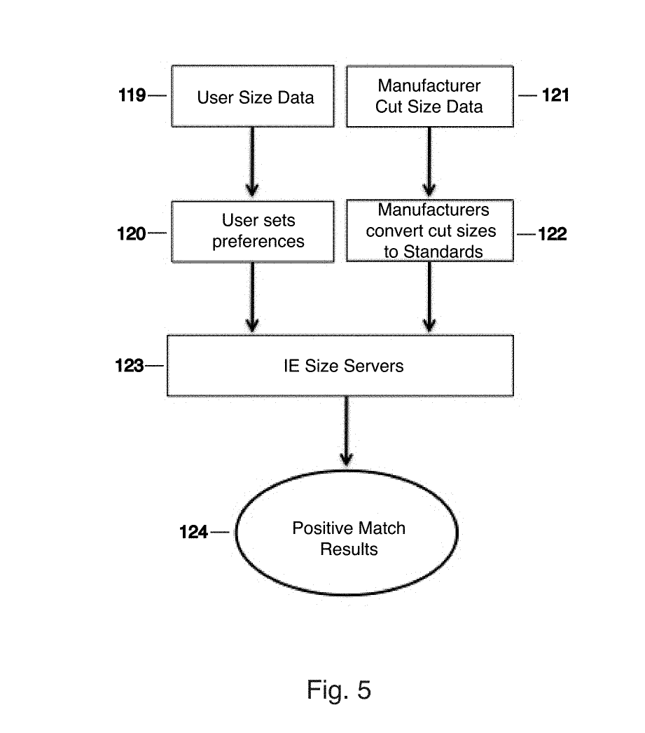

FIG. 5 Size matching process. This is a flowchart view of the size matching process, how manufacturer cut size data and user body size data has to be inputted in order to get positive matching results on IE Size Servers. Plan View.

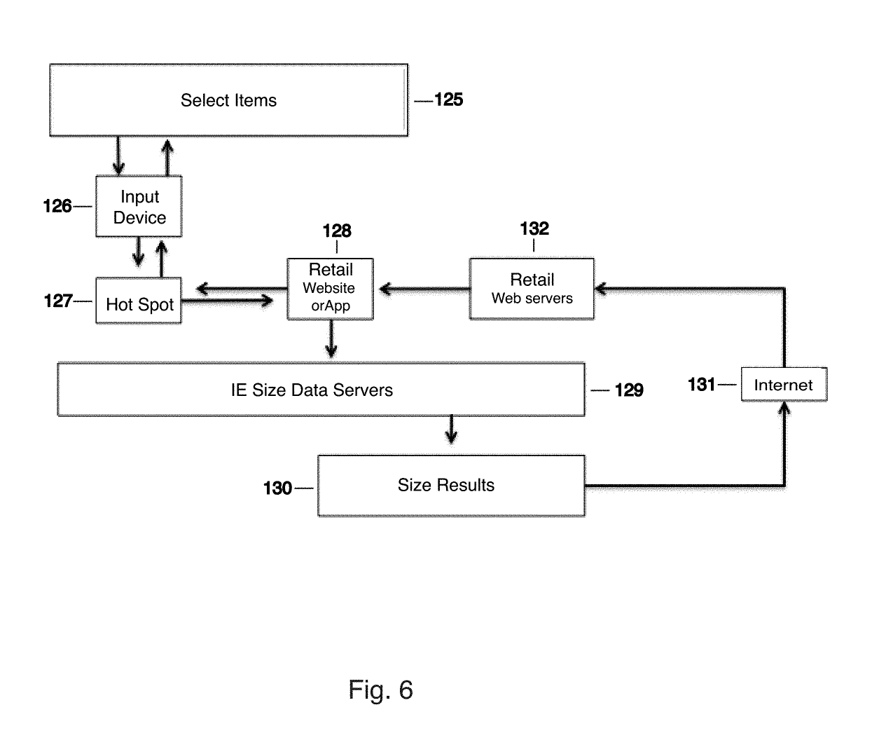

FIG. 6 Retail website process. This is a flowchart view of the retail website process, the new workflow process for the user, retailer websites, and IE Size data servers to interact. Plan View.

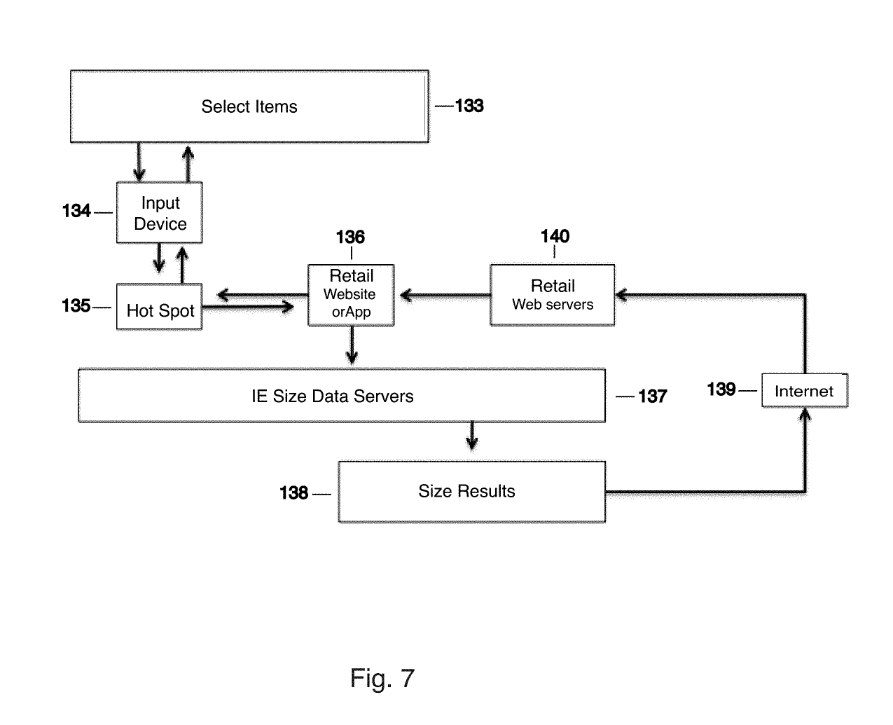

FIG. 7 User shopping process. This is a flowchart view of the user shopping process, the new workflow process for the user, retailer websites, and IE Size data servers to interact. Plan View.

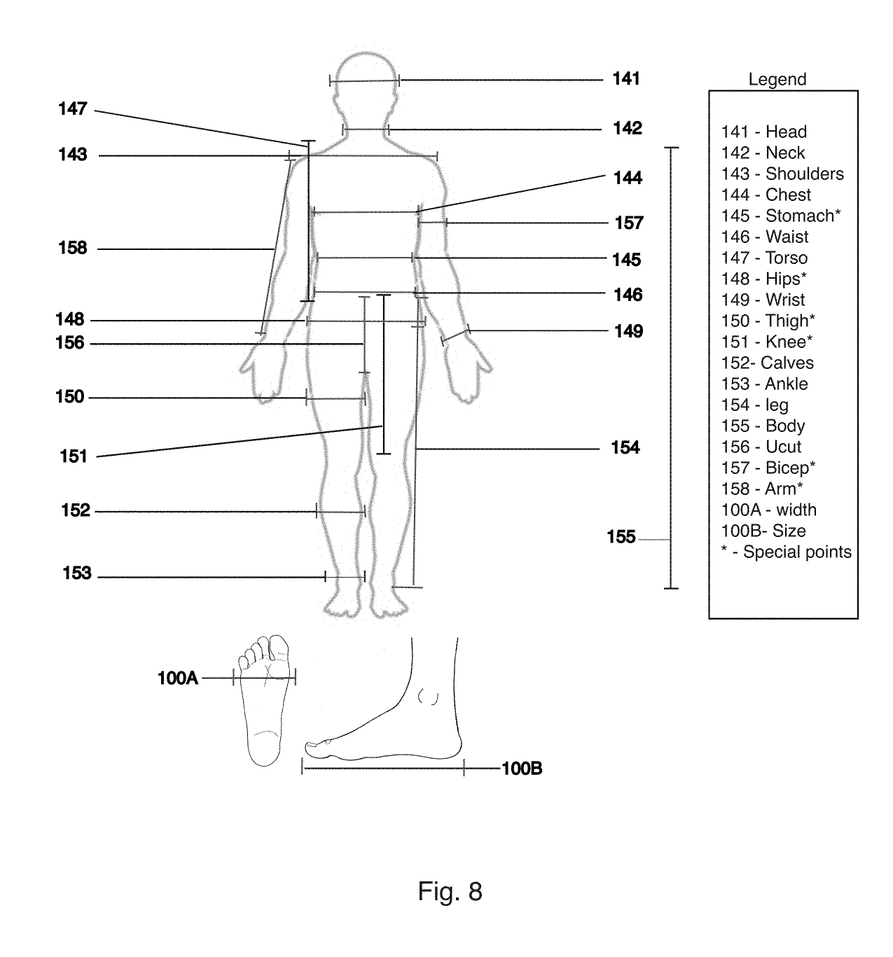

FIG. 8 Male Body Measuring points. User Input process detail. This is a detailed view of male body measuring points which are entered through the user input process. Plan View.

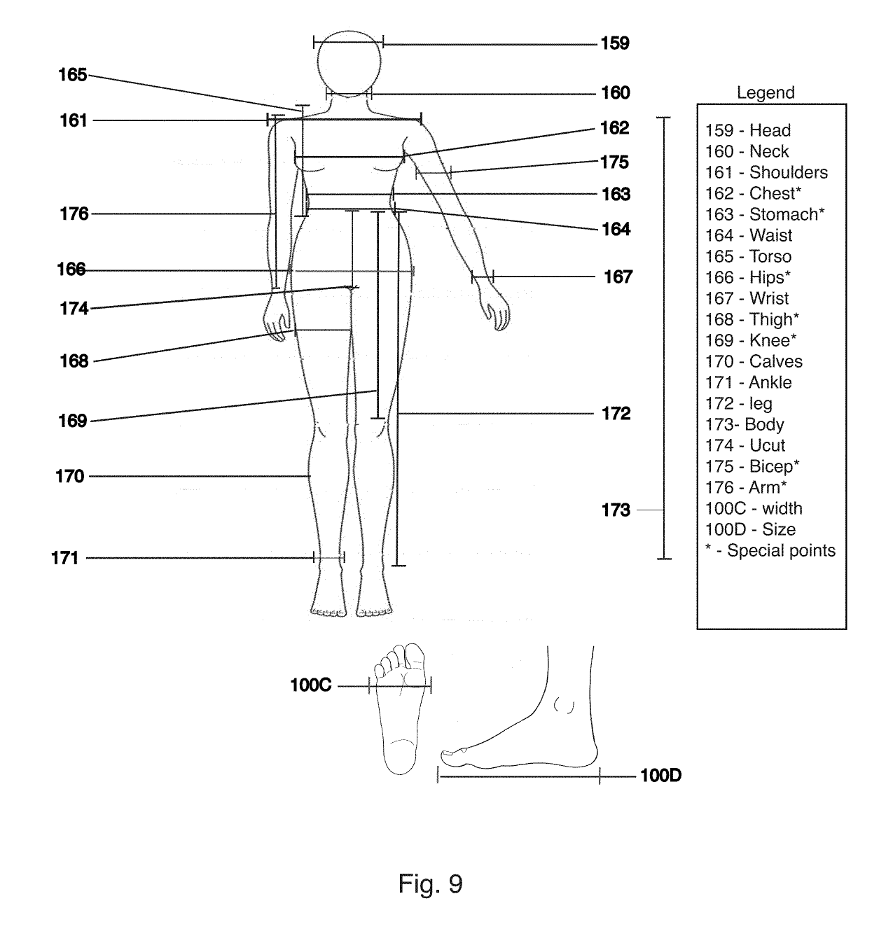

FIG. 9 Female Body Measuring points. User Input process detail. This is a detailed view of female body measuring points which are entered through the user input process. Plan View.

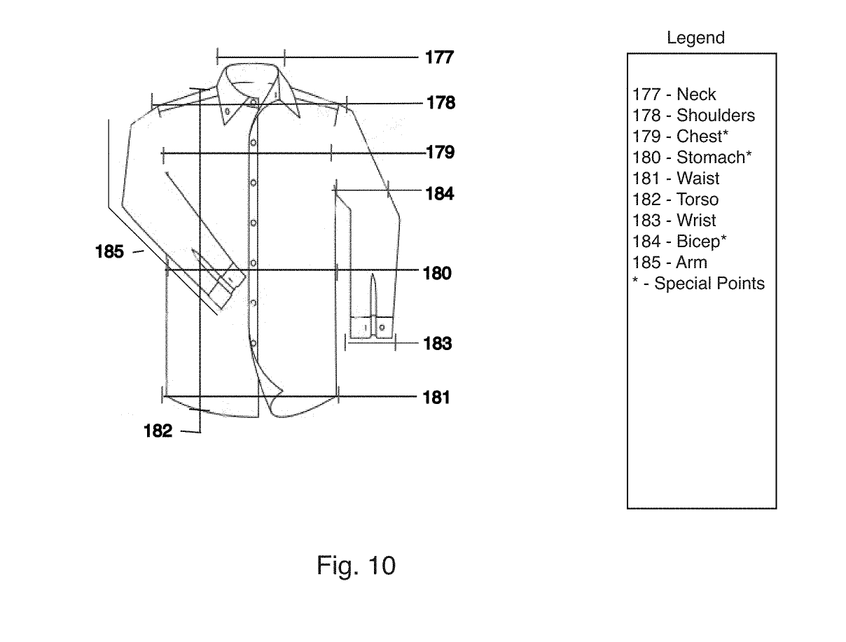

FIG. 10 Collared Shirt Measuring points. Manufacturer input process detail. This is an illustration and detailed view of the cut size measuring points which are needed to be inputted by the manufacturer for collared shirts. Plan View.

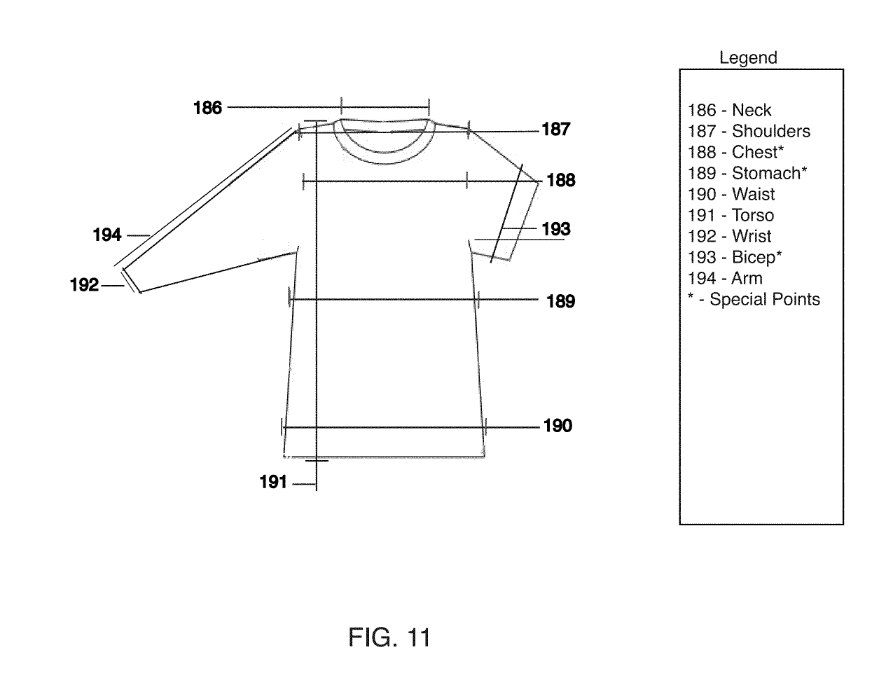

FIG. 11 T Shirt Measuring points. Manufacturer input process detail. This is a detailed view of the cut size measuring points which are needed to be inputted by the manufacturer for t shirts or uncollared shirts, sweaters, and sweatshirts. Plan View.

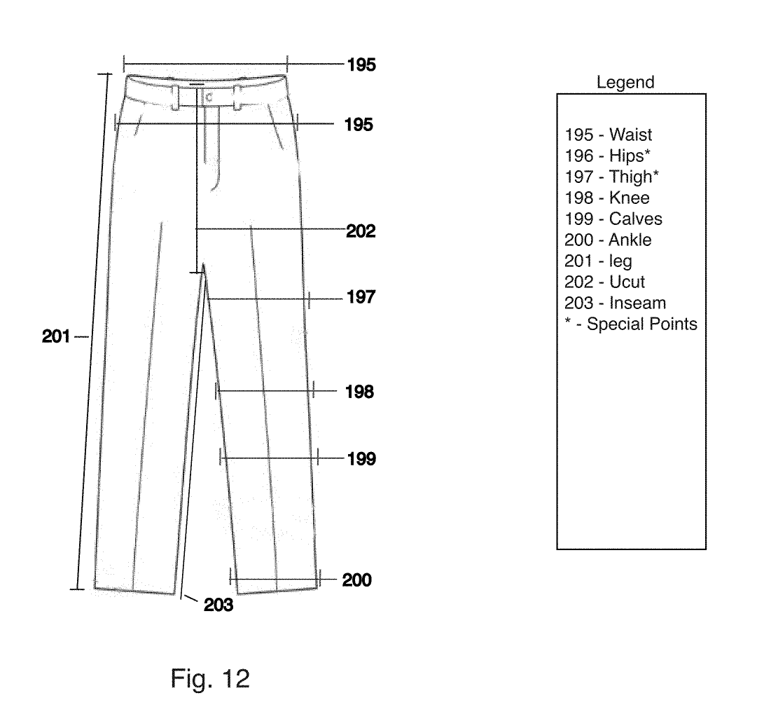

FIG. 12 Pants Measuring points. Manufacturer input process detail. This is an illustration and detailed view of the cut size measuring points which are needed to be inputted by the manufacturer for pants. Plan View.

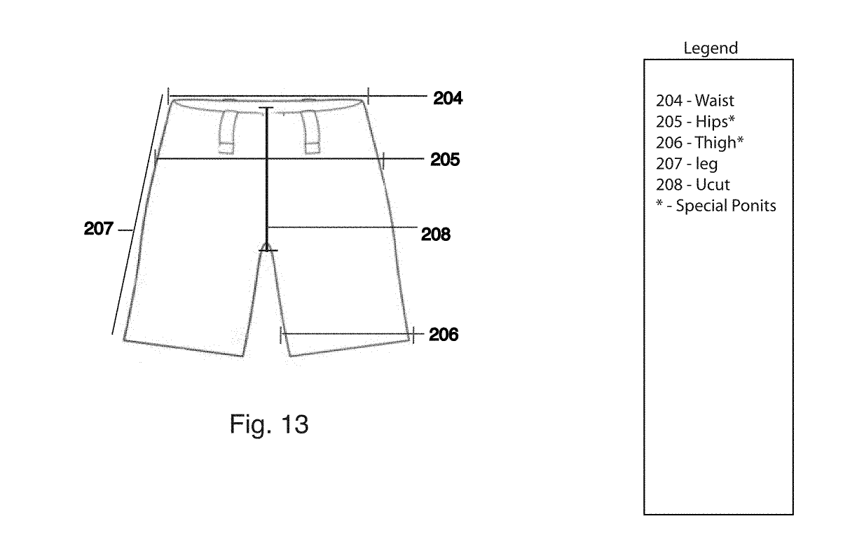

FIG. 13 Shorts Measuring points. Manufacturer input process detail. This is an illustration and detailed view of the cut size measuring points which are needed to be inputted by the manufacturer for shorts. Plan View.

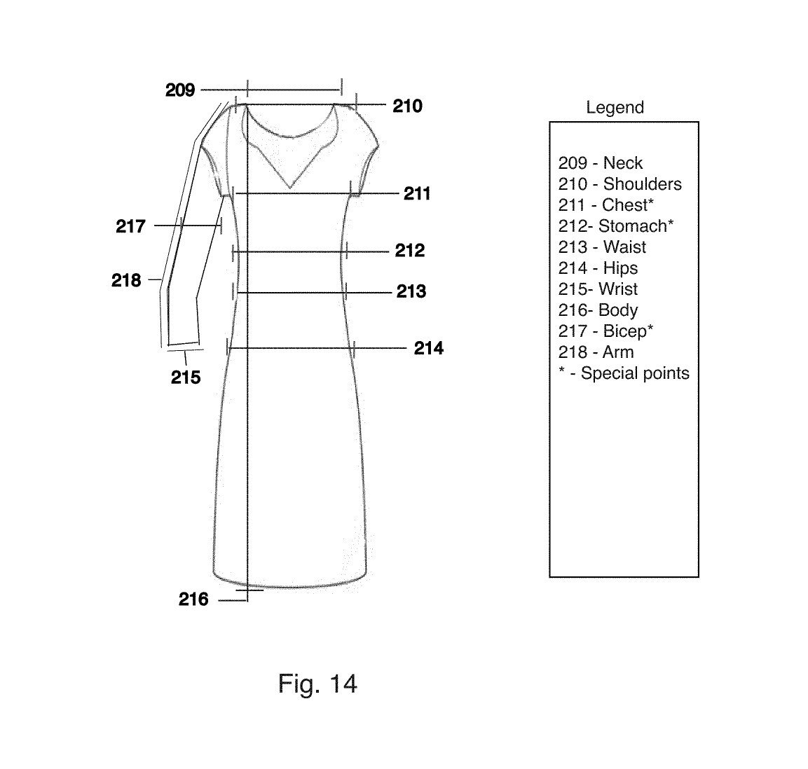

FIG. 14 Dress Measuring points. Manufacturer input process detail. This is an illustration and detailed view of the cut size measuring points which are needed to be inputted by the manufacturer for dresses. Plan View.

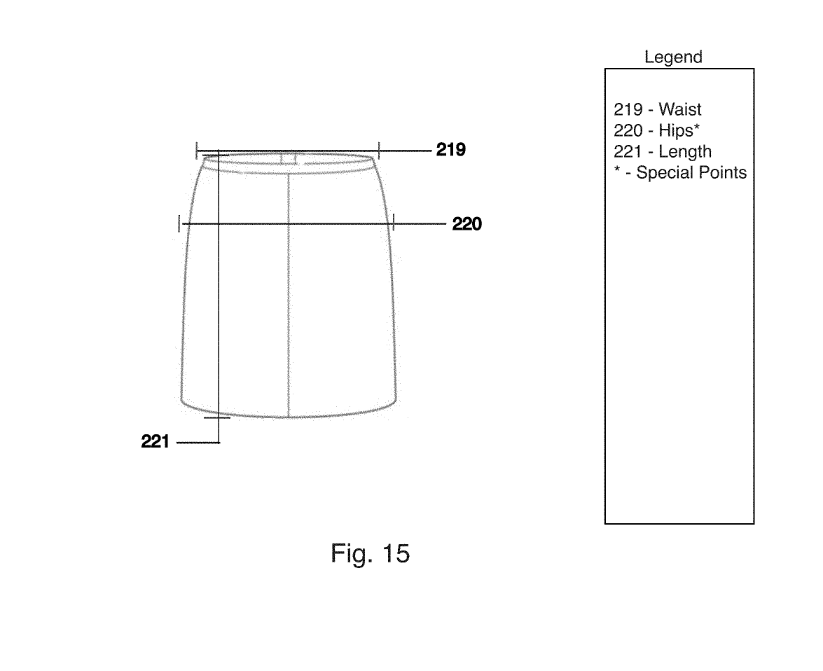

FIG. 15 Skirt Measuring points. Manufacturer input process detail. This is an illustration and detailed view of the cut size measuring points which are needed to be inputted by the manufacturer for skirts. Plan View.

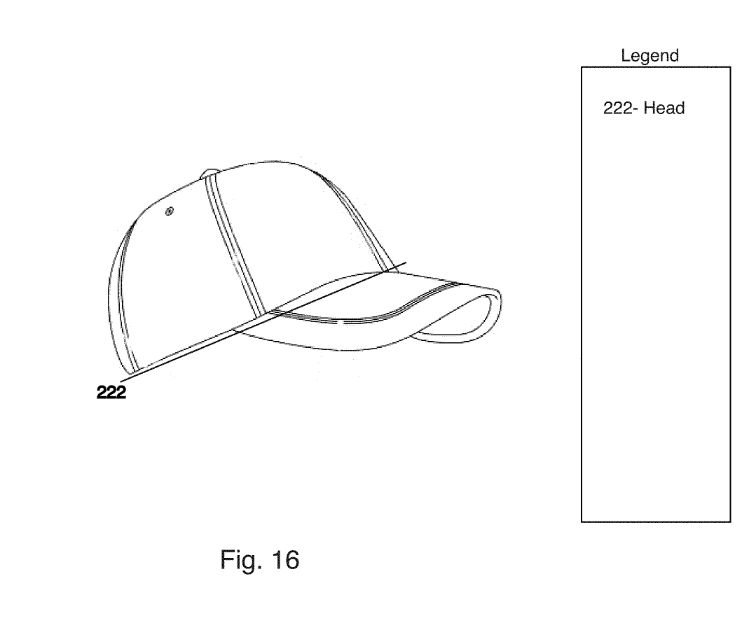

FIG. 16 Hat Measuring points. Manufacturer input process detail. This is an illustration and detailed view of the cut size measuring points which are needed to be inputted by the manufacturer for hats. Plan View.

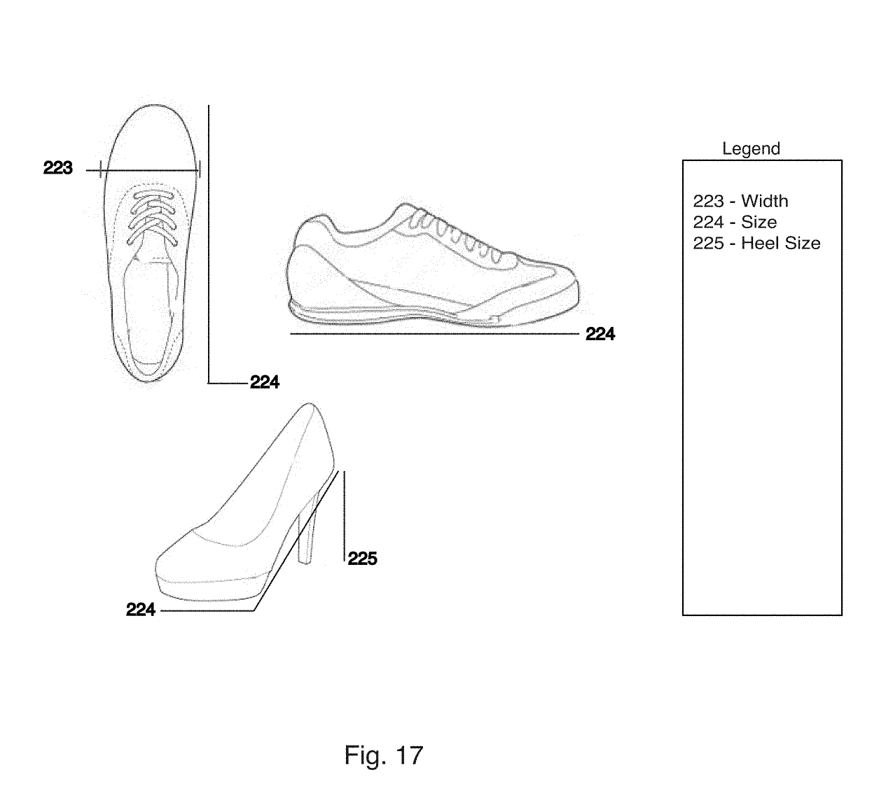

FIG. 17 Shoe Measuring points. Manufacturer input process detail. This is an illustration and detailed view of the cut size measuring points which are needed to be inputted by the manufacturer for shoes.

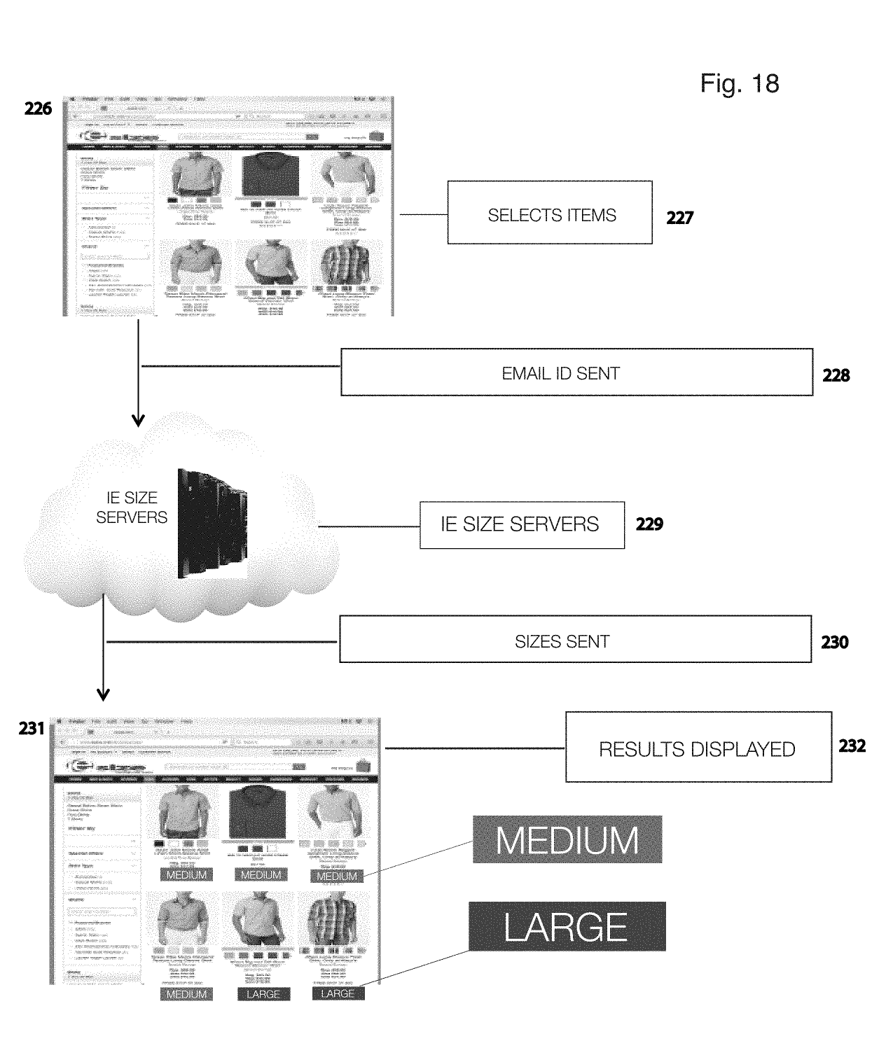

FIG. 18 Shopping Process Example. This is an example of how the shopping experience is designed to be utilized by the retailers and users to communicate correct results in the background. What a user doesn't see happening behind the scenes. Plan View.

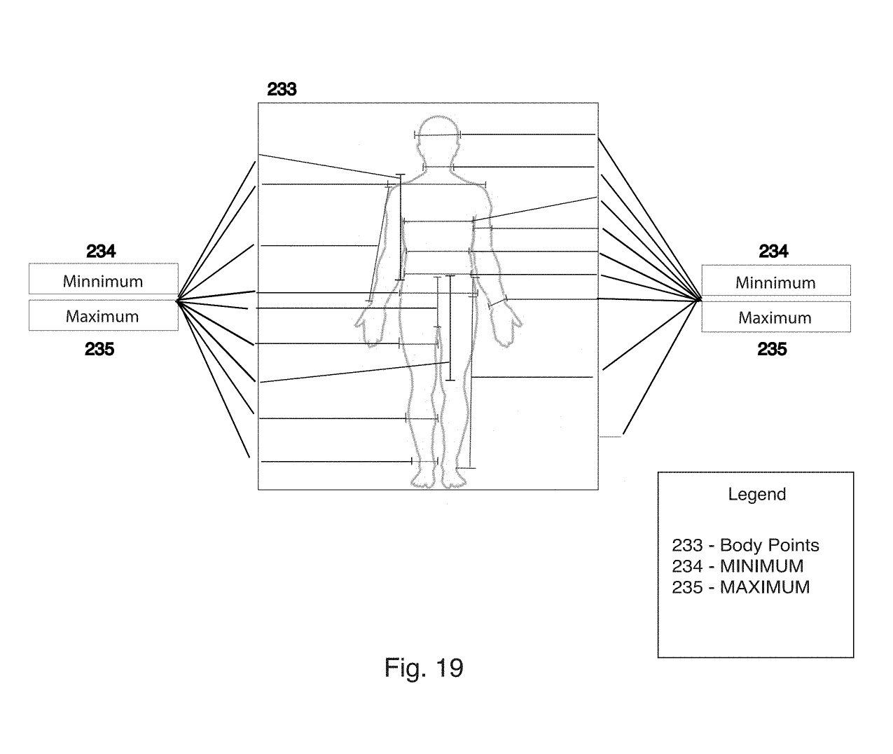

FIG. 19 Preferred Fit Strategy. Additional Size Points. This is an illustration showing minimum and maximum sizing points for all measuring points in the user input process. Plan View.

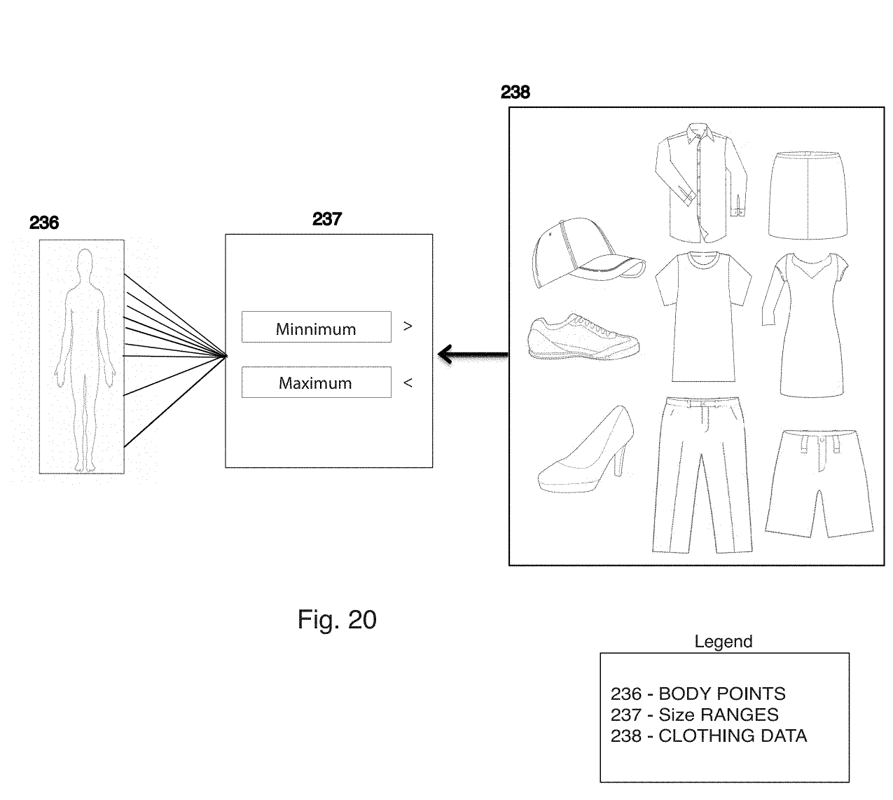

FIG. 20 Preferred Fit Strategy. Size Range Fit. This is an illustration showing the positive matching which occurs when items off all types fall into the preference points set up by users/consumers.

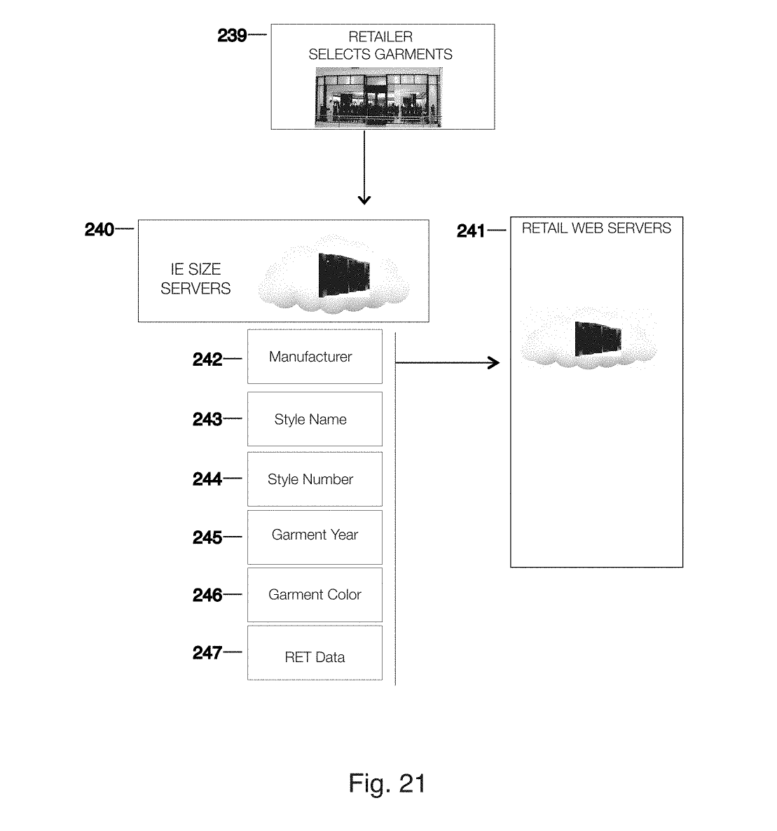

FIG. 21 Retail Input Process. Detail. This is a flowchart view of the retail input process, showing how the retailer selects garments from IE Size Servers, which will be the items they sell. Plan View.

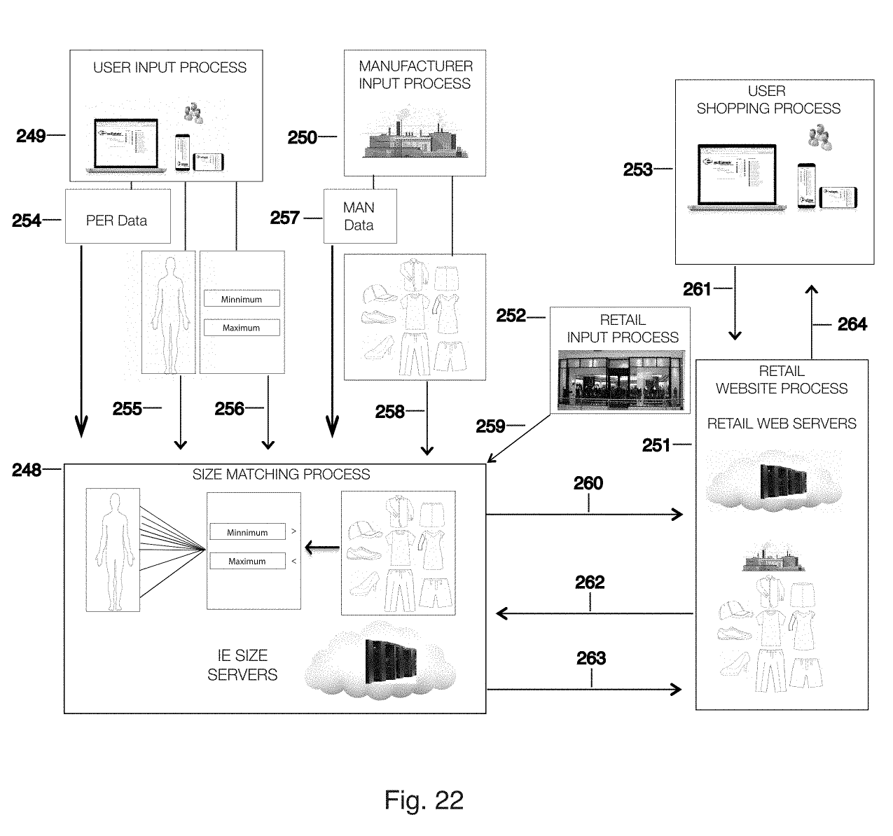

FIG. 22 Overall Process Strategy. This is an illustration showing the flow of data throughout all the major processes and also diagram items representing other data fields not shown, but needed, the major processes. Plan View.

### SUMMARY

All the processes, body points, and size ranges matter when a user is shopping online for Clothing. The user will now be able to shop online for garments once again with confidence, they know and understand better how they want their garments to fit. IE Size is a solution a method and process to get this major problem solved across the world.

### DETAILED DESCRIPTIONS OF THE DIAGRAMS SUBMITTED TO EXPLAIN ALL THE ITEMS NEEDED FOR THE METHOD AND PROCESS OF THE INVENTION

Note: an asterisk * in the diagrams and specification are special points which are often overlooked and not normally taken into consideration during the normal sizing process.

FIG. 1—Overview of Processes.

This is a flowchart view of all the overall processes needed to create a solution for better ordering of clothing items, the six major processes are shown here.

The manufacturer input process [101] is where manufacturers enter the cut size data of the garments they produce. The user input process [102] is where the user/consumer enters his or her personal size data and preferred fit information, which is how the user likes his clothes to fit. The retailer input process [104] is where the retailer will select the items, from the manufacturers, which they are currently selling. The IE Size Data Servers [103] represent the database systems which match the user size data to garment size data and garments manufactured to retailer stores and websites. The retailer web servers [105] will have their own interfaces to communicate correct size information back to the consumer in the user shopping process [106]. The user will then be able to see the correct size results based on his or her preferences.

### FIG. 1 Definitions

[101] Manufacturer input process which will be later described in (FIG. 2).
[102] User input process which will be later described in (FIG. 3).
[103] Size matching process—IE Size Data Servers. later described in (FIG. 5)
[104] Retailer input process which will be later described in (FIG. 4).
[105] Retail website process located on retailer web servers which will be later described in (FIG. 6).
[106] User shopping process which will be later described in (FIG. 7).

FIG. 2—Manufacturer Input Process.

This is a flowchart view of the manufacturer input process showing how a manufacturer will communicate with IE Size Servers.

Manufacturers enter the garments cut sizing data [107] the measurements of the clothing manufactured, by using an input device [108] any device that can browse the internet such as cell phone, computer, game console, handheld device that can access the web. Through the use of a hot spot [109] which is a device provided by an internet service provider (ISP) to grant access to the internet, in order to reach IE Size Data servers [110] which will hold and match the data. Manufacturer input process detail of garment cut size data will be described in FIG. 10-17. The measuring points for all the garment types to be inputted by the manufacturer.

### FIG. 2 Definitions

[107] Cut sizing data. The Manufacturer cut size data input for clothing or garment measuring points.
[108] Input Device. An input Device is to be any device that can shop online by using either a web browser or a custom app developed for android, ios, windows, macintosh, linux, unix or other.
[109] Hot Spot. Hot Spot is to be described as any direct or indirect connection being wired or wireless giving internet access to its user. Provided by an internet service provider (ISP).
[110] IE Size Data Servers. Database servers created with the intention of storing all data used by users, manufacturers and retailers to store and match data.

FIG. 3—User input process.

This is a flowchart view of the user input process showing how a user will communicate with IE Size Servers.

A user/consumer input sizing data [111] which is his or her personal size data body measurements, and also, what a user considers to be too big (maximum) or too small (minimum), by using an input device [112] any device that can browse the internet such as cell phone, computer, game console, handheld device that can access the web. Through the use of a hot spot [113] which is a device provided by an internet service provider (ISP) to grant access to the internet, in order to reach IE Size Data servers [114] which will hold and match the data. User input process body measuring point detail will be described in FIG. 9-10. Preference size Matching data will be described in FIG. 19-20.

### FIG. 3 Definitions

[111] Input sizing data. user personal size input measuring points data to be captured and stored.
[112] Input Device. An input Device is to be any device that can shop online by using either a web browser or a custom app developed for android, ios, windows, macintosh, linux, unix or other.
[113] Hot Spot. Hot Spot is to be described as any direct or indirect connection being wired or wireless giving internet access to its user. Provided by an internet service provider (ISP).
[114] IE Size Data Servers. Database servers created with the intention of storing all data used by users, manufacturers and retailers to store and match data.

FIG. 4—Retail Input Process.

This is a flowchart view of the retail input communication process how a user will communicate with IE Size Servers.

A retailer or retail direct manufacturer selects the items they sell, Select Items [115], by using an input device [116] any device that can browse the internet such as cell phone, computer, game console, handheld device that can access the web. Through the use of a hot spot [117] which is a device provided by an internet service provider (ISP) to grant access to the internet, in order to reach IE Size Data servers [118] which will hold and match the data.

### FIG. 4 Definitions

[115] Select Items. retail garments are selected, these are the items they intend to sell.
[116] Input Device. This Device is to be any device that can shop online by using either a web browser or a custom app developed for android, ios, windows, macintosh, linux, unix or other.
[117] Hot Spot. A hot spot is to be described as any direct or indirect connection being wired or wireless giving internet access to its user. Provided by an internet service provider (ISP).
[118] IE Size Data Servers. Database servers created with the intention of storing all data used by users, manufacturers and retailers to store and match data.

FIG. 5 Size Matching Process.

This is a flowchart view of the size matching process, how the data has to be broken down to get matching results on IE Size Servers.

The user/consumer enters his or her personal User size data [119] which are his or her body measurements, and also, a User sets preferences [120] what a user considers to be too big (maximum), or too small (minimum), specific to each body point measured. The manufacturers cut size data [121] are the garments cut size measurements. The manufacturers have deviated off the traditional sizing, so manufacturers convert cut sizes to standards [122] with the use of the precise cut size data, we can now determine what size the garment should be, adjust these items to conform to the fitting standards, to re-label them properly or set a true size. This will be done by having other data fields for size, there will be manufacturer size field and actual size field for the garment. The IE size servers [123] will match the garments to users, based on the user set preferences [120] the results will be a preferred fit for the user/consumer achieving positive match results [124].

### FIG. 5 Definitions

[119] User Size data. personal size input measuring points data to be utilized in the overall process.
[120] User Sets Preferences. When the user enters his data, he or she will input a minimum and maximum acceptable fit for those body points held by IE Size servers. IE Size servers will then determine what new size, based on extra material preferred, the user will now be. These conversions here are essential to creating a perfect desired fitment by the user.
[121] Manufacturer Cut size data. The actual cut size measuring points data of all the garments manufactured. These measuring points are detailed in FIG. 10-17.
[122] Manufacturer convert cut size to standards. Garments need to be evaluated by general size standards. Since garments are not being cut to any one specific standard le Size servers will determine what standard size the garment actually is based on actual cut not the label on the garment.
[123] IE Size Servers. Database servers created with the intention of storing all data used by users, manufacturers and retailers to store and match data.
[124] Positive match results. The size given when you relate user preferences to actual garment cut size data creating a preferred fitting size range.

FIG. 6 Retail Website Process.

This is a flowchart view of the retail website process, how the retail sales website needs to interact with IE Size servers.

A user/consumer will log onto a retailer or direct selling manufacturers retail website or App [128] giving them the ability to select items [125] they intend to purchase. By using an input device [126] any device that can browse the internet such as cell phone, computer, game console, handheld device that can access the web. Through the use of a hot spot [127] which is a device provided by an internet service provider (ISP) to grant access to the internet, by using a retail website or App[128], which is the user interface in order to send and retrieve data on IE Size Data servers [129] which will hold and match the data. The email address of the user will be communicated to IE Size Data servers [129] where the size matching garments are already matched to the users. The correct size results [130] are the returned through the internet service provider, internet [131] to the retail web servers [132] and then being displayed for the user/consumer on the retail website or app [128].

### FIG. 6 Definitions

[125] Select Items. Garments on the website are selected, and based on the users email address his sizing data can be accessed.
[126] Input Device. This Device is to be any device that can shop online by using either a web browser or a custom app developed for android, ios, windows, macintosh, linux, unix or other.
[127] Hot Spot. A Hot Spot is to be described as any direct or indirect connection being wired or wireless giving internet access to its user. Provided by an internet service provider (ISP).
[128] Retail website or App. Retailer websites will determine what the customer sees communicated back to the user
[129] IE Size Data Servers. Database servers created with the intention of storing all data used by users, manufacturers and retailers to store and match data.
[130] Size results. showing the user what size he is in this garment he wishes to buy based on his preferences for this garment type.
[131] Internet. Internet Service Provider (ISP). IE Size servers connectivity to the internet.
[132] Retail Web Servers. Retail web servers will communicate user requests and correct garment size data back to the user, through the website or App

FIG. 7 User Shopping Process.

This is a flowchart view of the user shopping process, how websites or apps, for the user need to interact with IE Size servers.

A user/consumer will log onto a retailer or direct selling manufacturers, retail website or App [136] giving them the ability to select items [133] they intend to purchase. By using an input device [134] any device that can browse the internet such as cell phone, computer, game console, handheld device that can access the web. Through the use of a hot spot [135] which is a device provided by an internet service provider (ISP) to grant access to the internet, by using a retail website or App[136], which is the user interface in order to send and retrieve data on IE Size Data servers [137] which will hold and match the data. The email address of the user will be communicated to IE size Data servers [137] where the size matching garments are already matched to the users. The correct size results [138] are the returned through the internet service provider, internet [139] to the retail web servers [140] and then being displayed for the user/consumer on the retail website or app [128].

### FIG. 7 Definitions

[133] Select Items. Garments on the website are selected, and based on the users email address his sizing data can be accessed.
[134] Input Device. This Device is to be any device that can shop online by using either a web browser or a custom app developed for android, ios, windows, macintosh, linux, unix or other.
[135] Hot Spot. A Hot Spot is to be described as any direct or indirect connection being wired or wireless giving internet access to its user.
[136] Retail website or App. Retailer websites will determine what the customer sees communicated back to the user
[137] IE Size Data Servers. Database servers created with the intention of storing all data used by users, manufacturers and retailers to store and match data.
[138] Size results. showing the user what size he is in this garment he wishes to buy based on his preferences for this garment type.
[139] Internet. Internet Service Provider (ISP). IE Size servers connectivity to the internet.
[140] Retail Web Servers. Retail web servers will communicate user requests and correct garment size data back to the user, through the website or App

FIG. 8 User Input Process Detail. Male Body Measuring Points.

These points are needed for user data collection on IE Size servers. These Male measuring points for a person are also database fields to be created to track and match this data. (data can be entered in american standard or metric). Minimum, and maximum measurement points will be created for each bodypoints with database fields to store this data as well. This is detailed male input in the user input process. A user inputs his or her measurements to complete a profile of their body size.

### FIG. 8 Definitions

[141] Head. Illustrates the area of the Head measured in circumference. Database fields to hold this data for head size, and metric will be created.
[142] Neck. Illustrates the area of the Neck measured in circumference. Database fields to hold this data for neck size, minimum, maximum, and metric will be created.
[143] Shoulders. Illustrates the area of the shoulders measured in width. Database fields to hold this data for shoulder size, minimum, maximum, and metric will be created.
[144] Chest. Illustrates the area of the chest measured in circumference. Database fields to hold this data for chest size, minimum, maximum, and metric will be created.
[145] Stomach. Illustrates the area of the stomach measured in circumference. Database fields to hold this data for stomach size, minimum, maximum, and metric will be created. * This is one of the missing crucial elements in the normal sizing process.
[146] Waist. Illustrates the area of the waist measured in circumference. Database fields to hold this data for waist size, minimum, maximum, and metric will be created.
[147] Torso. Illustrates the area of the Torso measured in length. Measured from waist to shoulders. Database fields to hold this data for torso size, and metric will be created.
[148] Hips. Illustrates the area of the Hips measured in circumference. Database fields to hold this data for hip size, minimum, maximum, and metric will be created. * This is one of the missing crucial elements in the normal sizing process.
[149] Wrist. Illustrates the area of the Wrist measured in circumference. Database fields to hold this data for wrist size, minimum, maximum, and metric will be created.
[150] Thigh. Illustrates the area of the Thigh measured in circumference. Database fields to hold this data for thigh size, minimum, maximum, and metric will be created. * This is one of the missing crucial elements in the normal sizing process.
[151] Knee. Illustrates the area of the Knee measured in length. Measured from waist to middle of kneecap. Database fields to hold this data for knee size and metric will be created. * This is one of the missing crucial elements in the normal sizing process.
[152] Calves. Illustrates the area of the Calves measured in circumference. Database fields to hold this data, minimum, maximum, and metric will be created.
[153] Ankle. Illustrates the area of the Ankle measured in circumference. Database fields to hold this data for ankle size and metric will be created.
[154] Leg. Illustrates the area of the Leg measured in length, Measured from waist to ankle. Database fields to hold this data for leg size and metric will be created.
[155] Body. Illustrates the area of the Body measured in length. Database fields to hold this data for body size and metric will be created.
[156] Ucut. Illustrates the area of the Ucut measured in length measured from the waist in the front to the waist on your back passing between your legs. Database fields to hold this data ucut size, minimum, maximum, and metric will be created.
[157] Bicep. Illustrates the area of the Bicep measured in circumference. Database fields to hold this data for bicep size, maximum, and metric will be created. * This is one of the missing crucial elements in the normal sizing process.
[158] Arm. This diagram also illustrates the area of the Arm or Sleeve length measured in length. Database fields to hold this data for arm size, minimum, maximum, and metric will be created. This is one of the missing crucial elements in the normal sizing process.
[100A] Width. A measurement for foot width. A database field to hold this data will be created.
[100B] Size. A measurement for foot length. A database field to hold this data will be created. * in the diagrams and specification are special points which are often overlooked and not normally taken into consideration during the normal sizing process.

FIG. 9 User Input Process Detail. Female Body Measuring Points.

These points are needed for user data collection on IE Size servers. These female measuring points for a person are also database fields to be created to track and match this data. (data can be entered in american standard or metric). Minimum, and maximum measurement points will be created for each bodypoints with database fields to store this data as well. A user inputs his or her measurements to complete a profile of their body size.

### FIG. 9 Definitions

[159] Head. Illustrates the area of the Head measured in circumference. Database fields to hold this data for head size, and metric will be created.
[160] Neck. Illustrates the area of the Neck measured in circumference. Database fields to hold this data for neck size, minimum, maximum, and metric will be created.
[161] Shoulders. Illustrates the area of the shoulders measured in width. Database fields to hold this data for shoulder size, minimum, maximum, and metric will be created.
[162] Chest. Illustrates the area of the chest measured in circumference. Database fields to hold this data for chest size, minimum, maximum, and metric will be created. * This is one of the missing crucial elements in the normal sizing process.
[163] Stomach. Illustrates the area of the stomach measured in circumference. Database fields to hold this data for stomach size, minimum, maximum, and metric will be created. * This is one of the missing crucial elements in the normal sizing process.
[164] Waist. Illustrates the area of the waist measured in circumference. Database fields to hold this data for waist size, minimum, maximum, and metric will be created. * This is one of the missing crucial elements in the normal sizing process.
[165] Torso. Illustrates the area of the Torso measured in length. Measured from waist to shoulders. Database fields to hold this data for torso size, and metric will be created.
[166] Hips. Illustrates the area of the Hips measured in circumference. Database fields to hold this data for hip size, minimum, maximum, and metric will be created. * This is one of the missing crucial elements in the normal sizing process.
[167] Wrist. Illustrates the area of the Wrist measured in circumference. Database fields to hold this data for wrist size, minimum, maximum, and metric will be created.
[168] Thigh. Illustrates the area of the Thigh measured in circumference. Database fields to hold this data for thigh size, minimum, maximum, and metric will be created. * This is one of the missing crucial elements in the normal sizing process.
[169] Knee. Illustrates the area of the Knee measured in length, Measured from waist to middle of kneecap. Database fields to hold this data for knee size and metric will be created. * This is one of the missing crucial elements in the normal sizing process.
[170] Calves. Illustrates the area of the Calves measured in circumference. Database fields to hold this data for calve size, minimum, maximum, and metric will be created.
[171] Ankle. Illustrates the area of the Ankle measured in circumference. Database fields to hold this data for ankle size and metric will be created.
[172] Leg. Illustrates the area of the Leg measured in length, Measured from waist to ankle. Database fields to hold this data for leg size and metric will be created.
[173] Body. Illustrates the area of the Body measured in length. Database fields to hold this data for body size and metric will be created.
[174] Ucut. Illustrates the area of the Ucut measured in length measured from the waist in the front to the waist on your back passing between your legs. Database fields to hold this data ucut size, minimum, maximum, and metric will be created.
[175] Bicep. Illustrates the area of the Bicep measured in circumference. Database fields to hold this data for bicep size, maximum, and metric will be created. * This is one of the missing crucial elements in the normal sizing process.
[176] Arm. This diagram also illustrates the area of the Arm or Sleeve length measured in length. Database fields to hold this data for arm size, minimum, maximum, and metric will be created. This is one of the missing crucial elements in the normal sizing process.
[100C] Width. A measurement for foot width. A database field to hold this data will be created.
[100D] Size. A measurement for foot length. A database field to hold this data will be created. * in the diagrams and specification are special points which are often overlooked and not normally taken into consideration during the normal sizing process.

FIG. 10 Manufacturer Input Process Detail. Collard Shirt Measuring Points.

This is an illustration of collared shirt measuring points needed for manufacturer garment data collection entered into IE Size data servers. The measuring points are the same for both male and female also the corresponding database fields to be created to track this data. (data can be entered in american standard or metric). Garment size data can be uploaded in bulk to IE Size data Servers as well.

### FIG. 10 Definitions

[177] Neck. Illustrates the area of the Neck opening. A database field to hold neck size and metric data will be created.
[178] Shoulders. Illustrates the area of the Shoulders width. A database field to hold shoulder size and metric data will be created.
[179] Chest. Illustrates the area of the chest size. A database field to hold chest size and metric data will be created. * This is one of the missing elements in the normal sizing process. (women only)
[180] Stomach. Illustrates the area of the Stomach size. A database field to hold stomach size and metric data will be created. * This is one of the missing crucial elements in the normal sizing process.
[181] Waist. Illustrates the area of the Waist size. A database field to hold bottom opening or waist size and metric data will be created.
[182] Torso. Illustrates the area of the Torso size or shirt length, Measured from waist to shoulders. A database field to hold torso size and metric data will be created.
[183] Wrist. Illustrates the area of the Wrist size opening. A database field to hold wrist size and metric data will be created.
[184] Bicep. Illustrates the area of the Bicep size or upper arm size. A database field to hold bicep size and metric data will be created. * This is one of the missing crucial elements in the normal sizing process.
[185] Arm. Illustrates the area of the Arm or sleeve length measured in length. A database field to hold arm size and metric data will be created. * in the diagrams and specification are special points which are often overlooked and not normally taken into consideration during the normal sizing process.

FIG. 11 Manufacturer Input Process Detail. T-Shirt Measuring Points.

This is an illustration of an uncollared T-shirt measuring points needed for manufacturer garment data collection entered into IE Size data servers. The measuring points are the same for both male and female also the corresponding database fields to be created to track this data. (data can be entered in american standard or metric). These measuring points can also be used for sweaters, sweatshirts tank tops, jackets and other garments. Garment size data can be uploaded in bulk to IE Size data Servers as well.

### FIG. 11 Definitions

[186] Neck. Illustrates the area of the Neck opening. A database field to hold neck size and metric data will be created.
[187] Shoulders. Illustrates the area of the Shoulders width. A database field to hold shoulder size and metric data will be created.
[188] Chest. Illustrates the area of the chest size. A database field to hold chest size and metric data will be created. * This is one of the missing elements in the normal sizing process. (women only)
[189] Stomach. Illustrates the area of the Stomach size. A database field to hold stomach size and metric data will be created. * This is one of the missing crucial elements in the normal sizing process.
[190] Waist. Illustrates the area of the Waist size. A database field to hold bottom opening or waist size and metric data will be created.
[191] Torso. Illustrates the area of the Torso size or shirt length, Measured from waist to shoulders. A database field to hold torso size and metric data will be created.
[192] Wrist. Illustrates the area of the Wrist size opening. A database field to hold wrist size and metric data will be created.
[193] Bicep. Illustrates the area of the Bicep size or upper arm size. A database field to hold bicep size and metric data will be created. * This is one of the missing crucial elements in the normal sizing process.
[194] Arm. Illustrates the area of the Arm or sleeve length measured in length. A database field to hold arm size and metric data will be created. * in the diagrams and specification are special points which are often overlooked and not normally taken into consideration during the normal sizing process.

FIG. 12 Manufacturer Input Process Detail. Pants Measuring Points.

This is an illustration of pants measuring points needed for manufacturer garment data collection entered into IE Size data servers. The measuring points are the same for both male and female also the corresponding database fields to be created to track this data. (data can be entered in american standard or metric). These measuring points can also be used for slacks, Jeans, Sweatpants, chuckers and other garments. Garment size data can be uploaded in bulk to IE Size data Servers as well.

### FIG. 12 Definitions

[195] Waist. Illustrates the area of the Waist size. A database field to hold bottom opening or waist size and metric data will be created.
[196] Hips. Illustrates the area of the Hips size. A database field to hold hip size and metric data will be created. * This is one of the missing crucial elements in the normal sizing process.
[197] Thigh. Illustrates the area of the thigh size. A database field to hold thigh size and metric data will be created. * This is one of the missing crucial elements in the normal sizing process.
[198] Knee. Illustrates the area of the Knee size, Measured from waist to middle of kneecap. Database fields to hold knee size and metric data will be created.
[199] Calves. Illustrates the area of the Calves measured in circumference. Database fields to hold calve size and metric data will be created.
[200] Ankle. Illustrates the area of the Ankle size or the bottom opening. Database fields to hold ankle size and metric data will be created.
[201] Leg. Illustrates the area of the Leg measured in length, Measured from waist to ankle. Database fields to hold leg size and metric data will be created.
[202] Ucut. Illustrates the area of the Ucut size. Database fields to hold ucut size and metric data will be created.
[203] Inseam. Illustrates the area of the Inseam size. Database fields to hold inseam size and metric data will be created. * in the diagrams and specification are special points which are often overlooked and not normally taken into consideration during the normal sizing process.

FIG. 13 Manufacturer Input Process Detail. Shorts Measuring Points.

This is an illustration of shorts measuring points needed for manufacturer garment data collection entered into IE Size data servers. The measuring points are the same for both male and female also the corresponding database fields to be created to track this data. (data can be entered in american standard or metric). Garment size data can be uploaded in bulk to IE Size data Servers as well.

### FIG. 13 Definitions

[204] Waist. Illustrates the area of the Waist size. A database field to hold bottom opening or waist size and metric data will be created.
[205] Hips. Illustrates the area of the Hips size. A database field to hold hip size and metric data will be created. * This is one of the missing crucial elements in the normal sizing process.
[206] Thigh. Illustrates the area of the thigh size. A database field to hold thigh size and metric data will be created. * This is one of the missing crucial elements in the normal sizing process.
[207] Leg. Illustrates the area of the Leg measured in length, Measured from waist to ankle. Database fields to hold leg size and metric data will be created.
[208] Ucut. Illustrates the area of the Ucut size. Database fields to hold ucut size and metric data will be created. * in the diagrams and specification are special points which are often overlooked and not normally taken into consideration during the normal sizing process.

FIG. 14 Manufacturer Input Process Detail. Dress Measuring Points.

This is an illustration of dress measuring points needed for manufacturer garment data collection entered into IE Size data servers. Database fields are created to track this data. (data can be entered in american standard or metric). Garment size data can be uploaded in bulk to IE Size data Servers as well.

### FIG. 14 Definitions

[209] Neck. Illustrates the area of the Neck opening. A database field to hold neck size and metric data will be created.
[210] Shoulders. Illustrates the area of the Shoulders width. A database field to hold shoulder size and metric data will be created.
[211] Chest. Illustrates the area of the chest size. A database field to hold chest size and metric data will be created. * This is one of the missing elements in the normal sizing process. (women only)
[212] Stomach. Illustrates the area of the Stomach size. A database field to hold stomach size and metric data will be created. * This is one of the missing crucial elements in the normal sizing process.
[213] Waist. Illustrates the area of the Waist size. A database field to hold bottom opening or waist size and metric data will be created.
[214] Hips. Illustrates the area of the Hips size. A database field to hold hip size and metric data will be created. * This is one of the missing crucial elements in the normal sizing process.
[215] Wrist. Illustrates the area of the Wrist size opening. A database field to hold wrist size and metric data will be created.
[216] Body. Illustrates the area of the Body measured in length. Database fields to hold body size and metric data will be created.
[217] Bicep. Illustrates the area of the Bicep size or upper arm size. A database field to hold bicep size and metric data will be created. * This is one of the missing crucial elements in the normal sizing process.
[218] Arm. Illustrates the area of the Arm or sleeve length measured length. A database field to hold arm size and metric data will be created. * in the diagrams and specification are special points which are often overlooked and not normally taken into consideration during the normal sizing process.

FIG. 15 Manufacturer Input Process Detail. Skirt Measuring Points.

This is an illustration of skirt measuring points needed for manufacturer garment data collection entered into IE Size data servers. Database fields are created to track this data. (data can be entered in american standard or metric). Garment size data can be uploaded in bulk to IE Size data Servers as well. The skirt length data can be compared your knee measurement to calculate a proper length fitting.

### FIG. 15 Definitions

[219] Waist. Illustrates the area of the Waist size. A database field to hold bottom opening or waist size and metric data will be created.
[220] Hips. Illustrates the area of the Hips size. A database field to hold hip size and metric data will be created. * This is one of the missing crucial elements in the normal sizing process.
[221] Length. Illustrates the area of the skirt measured in Length, Measured from waist to bottom of the skirt. A Database field to hold length size and metric data will be created. * in the diagrams and specification are special points which are often overlooked and not normally taken into consideration during the normal sizing process.

FIG. 16 Manufacturer Input Process Detail. Hat Measuring Points.

This is an illustration of skirt measuring points needed for manufacturer garment data collection entered into IE Size data servers. Database fields are created to track this data. (data can be entered in american standard or metric).

### FIG. 16 Definitions

[222] Head. Illustrates the area of the Head measured in circumference. A database field to hold this data will be created.

FIG. 17 Manufacturer Input Process Detail. Shoe Measuring Points.

This is an illustration of shoe measuring points needed for data collection entered into IE Size data servers. The measuring points are the same for both male and female also the corresponding database fields to be created to track this data. (data can be entered in american standard or metric). There are different measuring standards around the world for shoes so knowing the country of origin can help when ordering shoes online. Garment size data can be uploaded in bulk to IE Size data Servers as well.

### FIG. 17 Definitions

[223] Width. A measurement for foot width. A database field to hold this data will be created.
[224] Size. A measurement for foot length. A database field to hold this data will be created.
[225] Heel Size. A measurement for heel size, measured in height. A database field to hold this data will be created.

FIG. 18 Shopping Process Example.

Illustrates the shopping workflow design concept behind the unique background retail application IE Size has created for consumers, on a retail website or and ios android application built to interact between users and retailers have full access to IE Size servers.
[226] Retail Website. (not logged in) This illustrates the un logged in state of a retail or manufacturer direct website process as seen normally. The user does not have access to his sizing data for those garments, when he logs in the screen should change to the logged in view.
[227] Selects items. Users will log in to a online retail website and select items. Based on their unique identifier (EMAIL Address) the retail servers can access IE Size servers to then see if the customer data is present. If the customers size data is present, the retailer website will have access to the size data of the consumer.
[228] Email ID Sent. The users Email address is sent to ie size servers.
[229] IE Size Servers. IE Size Server Interaction explained. When the consumer logs in to the retail website [231], the retail website will interact with IE Size servers [229] through an IE Size database API. The Consumers account information and size data are saved in IE Size Servers. IE Size Servers calculations can link the customers personal sizing data to items in the IE Size servers linking him to every item manufactured and entered into IE Size Servers. Each user will have their preferences in how they like their items to fit, and IE Size will use this criteria to create an ideal fit for each garment. Each garment on the retail website will be able to display the size that is the ideal fit for the customer browsing the site.
[230] Sizes sent. Correct Sizes based on user preferences are sent from IE size servers to retail web servers or apps matching the garments being browsed.
[231] Retail Website. (user logged in) This illustrates the logged in state of a retail or manufacturer direct website as seen powered by IE Size Servers. The user now can see his preferred size for those garments which he has on the screen, showing him what size fits him the best.
[232] Results displayed. This example shows the site items displayed with the consumers sizes of the items and the best fit size for him or her, on the webpage or app items being browsed. IE Size new approach and concept will increase consumer confidence and they will know the items they purchase will fit them properly.

FIG. 19 Preferred Fit Strategy. Additional Size Points.

Illustrates that there are additional sizes and fields to be captured for all body points [233] to create this preferred fit strategy. What a user considers to be too small (too tightly fitting) minimum [234], or to big (too loosely fitting) Maximum [235]. The user inputting desired ranges when shopping will also be describing their problem areas, of their bodies, in the process.

### FIG. 19 Definitions

[233] Body Points. Just used as an example to show that users have different preferences for different parts of their bodies, which differ by user and clothing type.
[234] Minimum. This figure represents that for each measuring point on a person's body, the user feels that this length in, american standard or metric, is how much extra material is desired for the user to feel comfortable wearing this garment. A user must take into consideration abdominal bloating and other factors to determine how much extra material is their preferred fit. Too small or to tight.
[235] Maximum. This figure represents that for each measuring point on a person's body, the user feels that this length in, american standard or metric, is how much extra material is desired for the user to feel that this garment is too big to wear. This is what each user considers an item to be just too big for them.

FIG. 20 Preferred Fit Strategy. Size Range Fit.

Illustrates IE size revolutionary preferred fit strategy. This view shows how garments that fit the user are determined by the users preferences. This view shows the result of how this process is accomplished. This figure should be used as the title image for the invention. The User data body points [236] are measured and based on those points the Size Ranges [237] created based on, minimum and maximum, preference points are set. Now the Clothing data [238], (the exact cut size data inputted by the manufacturer) the garments whose cut size data is between the desired size ranges for the user/consumer, will now match and show the proper size of any garment matching the desired fit for the user.

### FIG. 20 Definitions

[236] Body Points. Body points, shows the different parts of their body. (overview)
[237] Size Ranges. Size ranges, are the minimums and maximums for the different parts, of the users body measured. Garments in this range will be the desired fit.
[238] Clothing Data. The precise cut size data of garments entered by the manufactures.

FIG. 21 Retail Input Process Detail.

This is a process workflow view where The Retailer or direct selling manufacturer, creates an account on IE Size Servers. On le Size Size Servers [240], The Retailer selects garments [239] they are selling in their stores and on their websites. The user selects the manufacturer [242] and then, the style name [243], the style number [244], the garment year [245], the garment Color [246]. The various other Ret Data [247] are entry fields not shown, which will be described below. This data will then be saved and sent to the retail web servers [241], which then will be beneficial to the retailers and users.

### FIG. 21 Definitions

[239] Retailer Selects Garments. The retailer or direct selling manufacturer selects the garments they sell and adds them to their web store or to their retail store adding inventory in the process. This Garment data is sent to the retail web servers specified by them.
[240] IE Size Data Servers. Database store all the data for all processes, users, manufacturers and retailers to match the data and make this process possible.
[241] Retail Web Servers. Retail web servers will store the correct garment data on their servers in order to better interface with the user.
[242] Manufacturer. A database field to store the manufacturer of a garment will be created.
[243] Style Name. A database field to store the style name of a garment will be created.
[244] Style Number. A database field to store the style number of a garment will be created.
[245] Garment Year. A database field to store the Garment Year of a garment will be created.
[246] Garment Color. A database field to store the Garment Year of a garment will be created.
[247] RET Data. All other database fields needed to store retail and garment data are listed below.
   Store Name. A database field to hold retail store name will be created.
   Store ID. A database field to hold store ID will be created.
   Store Address. A database field to hold store address location will be created.
   Store City. A database field to hold store city of a garments location will be created.
   Store State. A database field to hold store state of a garments location will be created.
   Store Zip. A database field to hold store zip code will be created.
   Item Size. A database field to hold of item size will be created.
   Item Quantity. A database field to hold item quantity, of a garment, at a location will be created.
   Login. A database field to hold store user login data will be created.
   Password. A database field to hold store user password data, will be created.
   Country. A database field to hold country of origin data of a garment will be created.
   Gender. A database field to hold gender data of a garment will be created.
   Unit. A database field to hold unit of measure data of a garment will be created.
   Garment Type. A database field to garment type category of a garment will be created.

FIG. 22 Overall Process Strategy.

This is an illustration showing the flow of data throughout all the major processes and also diagram items representing other data fields not shown, but needed, the major processes.

The user sets up an account, measures his or her body, and in the user input process [249] inputs their body size data [255] he or she then sets minimum and maximum preferences [256] and along with PER data [254], which are other database fields not displayed in drawings, a users profile will be complete. All user input process data is sent and stored on IE Size Servers [248]. In the manufacturer input Process [250] a manufacturer enters the cut size data [258] of the garments they manufacture and along Man Data [257], which are other database fields not displayed in drawings, All manufacturer input process data is sent and stored on IE Size Servers [248]. In the retail input process [252] retailers select the garments they sell from the manufacturers item data located on IE Size Servers [248], then this information will be sent [260] to retail web servers [251] to be stored and accessed whenever needed. In the user shopping process [253], a user selects garments on retail web servers [251] through a website or app, then the users email is sent [261] to the retail web servers [251], the email address is then relayed [262] to IE Size Servers [248] where the size matching process, based on the users up to date information is sent back [263], to the retail web servers [251], which is then displayed through the retail website or app located on the retail web servers, the size information sent to the user [264] to the user showing his or her positive match results for garments being browsed.

### FIG. 20 Definitions and Data Flow

[248] Size matching process—IE Size Servers. Where all data is stored and matched.
[249] User input process. where a user sets up a user account enters his or her body size measuring point data. and sets preferences by minimum and maximum.
[250] Manufacturer input process. Where a manufacturer enters cut size data of their garments.
[251] Retail website process located on retail web servers. This is where retailer interfaces to users are stored. Website infrastructure, inventory data user accounts shopping carts an so on.
[252] Retailer input process. Retailers select the items they sell from IE Size Servers.
[253] User shopping process Where a user shops online and sees what garments fit him or her by user set preferences.
[254] Per Data. User personal data which are other database fields needed, but not displayed in the drawings. These fields are essential to the IE Size Solution.
   Email. The email address, of the user will be a unique identifier for each user. A database field to hold the users email address will be created.
   Name. A database field to hold the users name data will be created.
   Password. A database field to hold the users name data will be created.
   Unit. A database field to hold metric or American standard will be created.
   Country. Country of which he is from to know what standards his or she is. A database field to hold this data will be created.
   Gender. A database field to hold the users gender data will be created.
[255] Shows the movement of Body size measuring point data sent to IE Size Servers.
[256] Shows the movement of Body size measuring point data sent to IE Size Servers.
[257] MAN Data. Manufacturer Garment data which are other database fields needed, but not displayed in drawings.
   Email. A database field to hold the manufacturer users email address will be created.
   Name. A database field to hold the manufacturer user name data will be created.
   Password. A database field to hold the manufacturer user password data will be created.
   Unit. A database field to hold metric or American standard will be created.
   Country. A database field to hold Country data will be created.
   Gender. A database field to hold the garment gender data will be created.
   Manufacturer. A database field to hold manufacturer data will be created.
   Style Number. A database field to hold Style number will be created.
   Style Name. A database field to hold Style name will be created.
   Year. A database field to hold the year of manufacture of a garment will be created.
   Type. A database field to hold garment type will be created.
   Size. A database field to hold size data will be created.
   Size2. A database field to hold alternate size data will be created.
[258] Shows the movement of Garment cut size measuring point data sent to IE Size Servers.
[259] Shows the Selection of Garments from the manufacturer databases on IE Size Servers.
[260] Shows the movement of Garments carried by retailers sent to Retail Web Servers.
[261] Shows the selection of Garments on Retail Web Servers.
[262] Shows the Request of user size information on located on IE Size Servers, by garments selected.
[263] Shows the Response of correct garment size information sent back to Retail Web Servers.
[264] Shows the Response of correct garment size data returned to the customer who is shopping online through the retail website or app.

1. There is a major problem that exists today with the sizing of clothing being different from each manufacturer. This is responsible for millions of dollars in returned merchandise and a diminished customer confidence level all throughout the world. IEsize is a new solution to this problem.
IEsize is a unique new approach taking custom measuring points of a person, and matching that info with all the measuring points, in clothing manufactured garments.
IEsize has developed a method and process to handle this issue.
1. IEsize will have a database built of a customer's personal exact sizing data to be inputted through a web based solution and held on its servers. Ie size intends to have IOS and android apps built for this input as well. Customers will enter their sizing measurements here.
2. IEsize will have a database built for a manufacturers garments by style, year, and manufacturer size of all the sizing points for each garment of manufacture. Manufacturers will enter their garment information here.
3. IEsize will have cloud based servers holding the data of both manufactured items and customer data for access through custom built databases holding all information.
4. IEsize will have different customer size range data, minimum and maximum acceptable size, customer preferences built into each specific measuring point. These measuring points, when all combined, will be able to automatically determine whether the related garment is a fit for the customer. Yes or No will be determined and if not where the garment does not meet the customers fitment.
5. IEsize will create databases to be accessed for retailers and customers. Each customer's unique email address will be used for customer login. Each manufacturer will have logins for data to be imported or updated by garment style number by garment year, we will also track materials used in each garment example: cotton, wool etc.
By doing this in this way IEsize will be able to tell each customer what size is right for them, based on what they prefer. There are different sizing standards and different measuring standards also. IEsize will calculate the different conversions needed for global retailers to sell more products, and customers to again shop with confidence.
